(19) United States
(12) Patent Application Publication
(10) Pub. No.: US 2025/0141027 A1
(43) Pub. Date: May 1, 2025

(54) ENERGY STORAGE MODULE AND BATTERY PACK

(71) Applicant: Jinko Energy Storage Technology Co., Ltd., Haining (CN)

(72) Inventors: Yuanfu LV, Haining (CN); Guochao CHEN, Haining (CN); Yuanhang CHEN, Haining (CN); Yadong LIANG, Haining (CN); Shaorong GE, Haining (CN)

(21) Appl. No.: 18/772,287

(22) Filed: Jul. 15, 2024

(30) Foreign Application Priority Data
Oct. 25, 2023 (CN) 202322873362.9
Apr. 3, 2024 (CN) 202410401280.0

(51) Int. Cl. H01M 50/264; H01M 50/209; H01M 50/244

(52) U.S. Cl. CPC H01M 50/264; H01M 50/209; H01M 50/244

(57) ABSTRACT

Provided are an energy storage module and a battery pack, including a body portion and at least one strip. The body portion includes a battery cell assembly and end plates arranged at two sides of the battery cell assembly in a length direction of the energy storage module. The strip is arranged around an outer side of the body portion along a circumferential direction of the body portion to fix the battery cell assembly and the end plates. A side of each of the end plates away from the battery cell assembly is provided with at least one engaging structure. The engaging structure includes an engaging space. Part of the strip is located in the engaging space to limit a relative position between the end plate and the strip. The engaging structure is arranged at the end plate to have a limiting effect on the strip.

### CROSS-REFERENCE TO RELATED APPLICATIONS

The present application claims priority to Chinese Application No. 202410401280.0, which is filed on Apr. 3, 2024, and Chinese Application No. 202322873362.9, which is filed on Oct. 25, 2023, the contents of which are incorporated herein by reference in their entireties.

### TECHNICAL FIELD

The present disclosure relates to the technical field of energy storage, and in particular to an energy storage module and a battery pack.

### BACKGROUND

With the development of science and technology, application fields of an energy storage device are becoming more and more extensive. As an important element in the energy storage device, a battery pack includes a plurality of energy storage modules. The energy storage modules each include a battery cell and an end plate. The battery cell and the end plate are fixed by a strip. However, currently, the strip is prone to deviation on the energy storage module, resulting in low stability of the strip on the energy storage module, thereby easily affecting normal operation of the energy storage module.

### SUMMARY

In view of this, the present disclosure provides an energy storage module and a battery pack to help solve the problem in the related art that the strip is prone to deviation.

In a first aspect, some embodiments of the present disclosure provide an energy storage module, including: a body portion, the body portion including a battery cell assembly and end plates arranged at two sides of the battery cell assembly in a length direction of the energy storage module; and at least one strip, the strip being arranged around an outer side of the body portion along a circumferential direction of the body portion to fix the battery cell assembly and the end plates. At least one engaging structure is provided at a side of each of the end plates away from the battery cell assembly, the engaging structure including an engaging space, and part of the strip is located in the engaging space to limit a relative position between the end plate and the strip.

In some embodiments of the present disclosure, the engaging structure includes a first engaging member and a second engaging member that protrude towards a direction away from the battery cell assembly. The first engaging member and the second engaging member are arranged at intervals along a height direction of the energy storage module, and the engaging space is located between the first engaging member and the second engaging member. In the height direction of the energy storage module, an end of the strip abuts against the first engaging member, and another end of the strip abuts against the second engaging member.

In some embodiments of the present disclosure, the second engaging member includes an engaging groove in communication with the engaging space; and part of the strip is located in the engaging groove to limit a position of the strip in the length direction of the energy storage module.

In some embodiments of the present disclosure, the first engaging member and the second engaging member are arranged at intervals along a width direction of the energy storage module.

In some embodiments of the present disclosure, at least one of the first engaging member or the second engaging member includes an engaging portion and a guiding portion; and in the height direction of the energy storage module, the engaging portion is located at a side of the guiding portion close to the engaging space and is connected to the guiding portion; and a cross-sectional area of the guiding portion decreases along a direction away from the engaging portion.

In some embodiments of the present disclosure, in a width direction of the energy storage module, a dimension of the first engaging member is less than a dimension of the second engaging member; and along the height direction of the energy storage module, a projection of the first engaging member is located within a projection of the second engaging member.

In some embodiments of the present disclosure, in the width direction of the energy storage module, a distance between a midpoint of the first engaging member and an end portion of the end plate is a first distance, and a distance between a midpoint of the second engaging member and the end portion of the end plate is a second distance; and the first distance is less than or equal to the second distance.

In some embodiments of the present disclosure, a protruding height of the second engaging member is greater than a protruding height of the first engaging member.

In some embodiments of the present disclosure, a protruding height of the first engaging member and/or the second engaging member ranges from 0 mm to 3 mm.

In some embodiments of the present disclosure, the second engaging member includes a guiding surface at an end close to the first engaging member; and an angle a formed between the guiding surface and the end plate ranges from 90° to 150°.

In some embodiments of the present disclosure, the engaging structure includes a recess arranged at the end plate, the recess is recessed towards the battery cell assembly, and the engaging space is located in the recess; and the strip includes an engaging protrusion engaged in the engaging space.

In some embodiments of the present disclosure, the engaging protrusion is provided with a fitting hole; and the engaging space is provided with a fitting protrusion that fits the fitting hole.

In some embodiments of the present disclosure, in a width direction of the strip, a ratio of a dimension of the engaging protrusion to a dimension of the strip ranges from 1% to 20%.

In some embodiments of the present disclosure, the end plate includes a side portion and corner portions located at two sides of the side portion, and the engaging structure is arranged at the side portion.

In some embodiments of the present disclosure, the energy storage module includes a collection assembly located at a side of the body portion along a height direction of the energy storage module; and the collection assembly includes a main body portion extending along the length direction of the energy storage module, and each of two ends of the main body portion is provided with a fitting portion connected to a corresponding end plate of the end plates; and the end plate is provided with a limiting portion at a side close to the collection assembly, the limiting portion is provided with a limiting groove along the height direction of the energy storage module, and the fitting portion includes a limiting protrusion extending towards the limiting portion; and the limiting protrusion is capable of extending into the limiting groove to limit a position of the main body portion.

In some embodiments of the present disclosure, the end plate is further provided with at least one fixation groove at a side of the limiting portion and extending along the height direction of the energy storage module, and the fixation groove is configured to mount and fix an electronic element in the energy storage module.

In some embodiments of the present disclosure, the fixation groove includes a first side wall and a second side wall arranged along a width direction of the energy storage module, each of the first side wall and the second side wall is provided with a protruding portion protruding towards an inner side of the fixation groove, and the protruding portion is configured to fit the electronic element.

In some embodiments of the present disclosure, the end plate is provided with a reinforcing rib at a side away from the battery cell assembly, the reinforcing rib includes at least a first reinforcing portion, the first reinforcing portion is provided with a first lifting hole along the length direction of the energy storage module, and the first lifting hole is configured to fit a lifting arm of a crane.

In some embodiments of the present disclosure, the end plate is provided with a second lifting hole and a third lifting hole along the length direction of the energy storage module; along a height direction of the energy storage module, a dimension of the third lifting hole is less than a dimension of the second lifting hole; and each of the second lifting hole and the third lifting hole is configured to fit a lifting arm of a crane.

In a second aspect, some embodiments of the present disclosure further provide a battery pack, including a housing and at least one energy storage module. The housing includes an accommodation space, in which the energy storage module is located, and the energy storage module is the energy storage module in any one of the above-mentioned embodiments.

Some embodiments of the present disclosure provide an energy storage module and a battery pack, including a body portion and at least one strip. The body portion includes a battery cell assembly and end plates arranged at two sides of the battery cell assembly along a length direction of the energy storage module. The strip is arranged around an outer side of the body portion along a circumferential direction of the body portion to fix the battery cell assembly and the end plates. A side of each of the end plates away from the battery cell assembly is provided with at least one engaging structure. The engaging structure includes an engaging space. Part of the strip is located in the engaging space to limit a relative position between the end plate and the strip. According to some embodiments of the present disclosure, the engaging structure is arranged at the end plate, and the engaging structure can have a limiting effect on the strip, thereby helping reduce a possibility of sliding deviation of the strip to improve stability of mounting of the strip and then helping improve stability of connection between the battery cell assembly and the end plate to ensure normal use of the energy storage module.

It should be understood that the general description above and the detailed description in the following are merely exemplary and cannot limit the present disclosure.

### BRIEF DESCRIPTION OF DRAWINGS

In order to better illustrate the technical solutions in embodiments of the present disclosure, the accompanying drawings used in the description of the embodiments will be briefly introduced below. It is apparent that the accompanying drawings in the following description are only some embodiments of the present disclosure, and other drawings can be obtained by those of ordinary skill in the art from the provided drawings without creative efforts.

FIG. 1 is a schematic diagram of an energy storage module according to some embodiments of the present disclosure;

FIG. 2 is a schematic diagram of an end plate in the energy storage module in FIG. 1;

FIG. 3 is an enlarged view of Part I in FIG. 1;

FIG. 4 is a schematic diagram of an energy storage module according to some embodiments of the present disclosure;

FIG. 5 is a schematic diagram of an end plate and a strip in an energy storage module according to some embodiments of the present disclosure;

FIG. 6 is a schematic diagram of an end plate in the energy storage module in FIG. 5;

FIG. 7 is a partial schematic diagram of an end plate and a strip in an energy storage module according to some embodiments of the present disclosure;

FIG. 8 is a partial sectional view taken along A1-A2 in FIG. 7;

FIG. 9 is a partial sectional view of the end plate in FIG. 8;

FIG. 10 is a schematic diagram of an end plate and a strip in an energy storage module according to some embodiments of the present disclosure;

FIG. 11 is a side view of FIG. 10;

FIG. 12 is a partial sectional view taken along B1-B2 in FIG. 11;

FIG. 13 is a schematic diagram of an end plate in an energy storage module according to some embodiments of the present disclosure;

FIG. 14 is a partial sectional view taken along B1-B2 in FIG. 13;

FIG. 15 is a schematic diagram of a strip according to some embodiments of the present disclosure;

FIG. 16 is a partial sectional view of the strip in FIG. 15;

FIG. 17 is an enlarged view of Part II in FIG. 1; and

FIG. 18 is a schematic diagram of a battery pack according to some embodiments of the present disclosure.

### REFERENCE SIGNS

10: energy storage module;
1: body portion;
11: battery cell assembly;
111: battery cell;
12: end plate;
121: cavity;
122: fitting end;
123: mounting hole;
124: side portion;
125: corner portion;
126: reinforcing structure;
127: recess;
13: engaging structure;
131: first engaging member;
131a: engaging portion;
131b: guiding portion;
132: engaging space;
133: second engaging member;
14: limiting portion;
141: limiting groove;
142: accommodation cavity;
15: fixation groove;
151: first side wall;
152: second side wall;
153: protruding portion;
16: reinforcing rib;
161: first reinforcing portion;
161a: first lifting hole;
162: second reinforcing portion;
163: third reinforcing portion;
164: fourth reinforcing portion;
17: second lifting hole;
18: third lifting hole;
2: strip;
21: engaging protrusion;
3: collection assembly;
31: main body portion;
32: fitting portion;
321: limiting protrusion;
20: housing.

### DESCRIPTION OF EMBODIMENTS

In order to better illustrate the technical solutions of the present disclosure, some embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts shall fall within the scope of protection of the present disclosure.

The terms used in the embodiments of the present disclosure are only for the purpose of describing specific embodiments and are not intended to limit the present disclosure. As used in the embodiments of the present disclosure and the appended claims, the singular forms of “a/an”, “one”, and “the” are intended to include plural forms, unless otherwise clearly specified in the context.

It should be understood that the term “and/or” used herein describes an association relationship between associated objects and represents that three relationships may exist. For example, A and/or B may represent the following three cases: only A exists, both A and B exist, and only B exists. In addition, the character “/” herein generally indicates an “or” relationship between the associated objects.

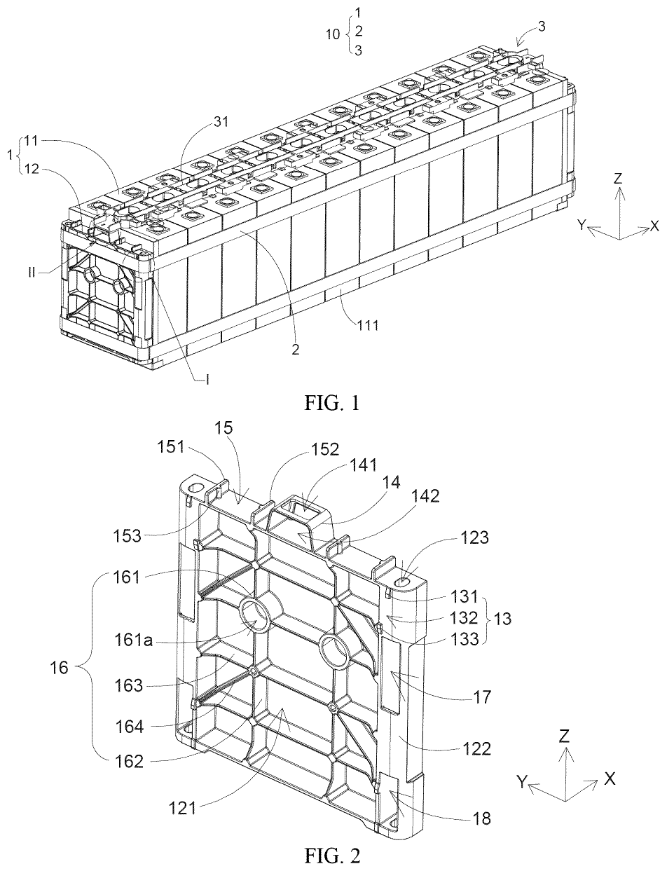

As shown in FIG. 1 to FIG. 3, some embodiments of the present disclosure provide an energy storage module 10, including a body portion 1 and at least one strip 2. The body portion 1 includes a battery cell assembly 11, and end plates 12 arranged at two sides of the battery cell assembly 11 in a length direction X of the energy storage module 10. The strip 2 is arranged around an outer side of the body portion 1 in a circumferential direction of the body portion 1 to fix the battery cell assembly 11 and the end plates 12. At least one engaging structure 13 is provided at a side of each of the end plates 12 away from the battery cell assembly 11. The engaging structure 13 includes an engaging space 132, in which a partial structure of the strip 2 is located, so as to limit a relative position of the end plate 12 and the strip 2

The body portion 1 includes two end plates 12. The two end plates 12 are located at two ends of the battery cell assembly 11, respectively. The strip 2 can provide a pre-tightening force to bundle and fix the battery cell assembly 11 and the two end plates 12 together. The battery cell assembly 11 includes a plurality of battery cells 111 arranged along the length direction X of the energy storage module 10. The battery cell 111 located at an outer side can abut against a corresponding end plate 12. The end plate 12 is provided with the engaging structure 13. The engaging structure 13 includes an engaging space 132 that can fit/match the strip 2. For example, when the strip 2 binds the body portion 1, the strip 2 passes through the engaging space 132, and the engaging space 132 can have a limiting effect on the strip 2, thereby limiting a relative position of the end plate 12 and the strip 2, helping reduce a possibility of sliding deviation of the strip 2 on the end plate 12 during mounting, transportation, and use of the energy storage module 10. In this way, it improves stability of fitness/matching between the strip 2 and the end plate 12, thereby helping improve stability of connection between the battery cell assembly 11 and the end plate 12, and helping improve reliability of the energy storage module 10.

Currently, the strip in the energy storage module is prone to deviation relative to the end plate, resulting in poor reliability of the strip, thereby affecting stability of connection between the battery cell assembly and the end plate. According to some embodiments of the present disclosure, the engaging structure 13 is provided at the end plate 12, and the engaging structure 13 can have a limiting effect on the strip 2, thereby helping reduce a possibility of sliding deviation of the strip 2 to improve stability of mounting of the strip 2 and then helping improve stability of the connection between the battery cell assembly 11 and the end plate 12 to ensure normal use of the energy storage module 10.

The energy storage module 10 may include a plurality of battery cell assemblies 11 to provide a higher voltage and capacity. A main function of the battery cell assembly 11 is to connect a plurality of battery cells 111 together to increase a voltage and an energy storage capacity of a battery system. Through parallel or series connection of the battery cells 111, the energy storage module 10 can meet electrical energy requirements of different applications. The series connection of the battery cells 111 can increase a total voltage, and the parallel connection of the battery cells 111 can increase a total capacity. The battery cell 111 is a minimum unit of a battery and also an electrical energy storage unit, which must have high energy density to store as much electrical energy as possible. In addition, the service life of the battery cell 111 is also the most critical factor. Damage to any battery cell 111 may cause damage to the entire battery pack.

For example, the energy storage module 10 may be a 350 module, a 390 module, or a 530 module.

The plurality of battery cells 111 are connected in series through busbars. For example, the battery cell 111 includes a positive electrode, a negative electrode, and an explosion-proof port. Two ends of a busbar are electrically connected to electrodes of two battery cells 111, respectively. For example, a busbar is electrically connected to the positive electrode of one battery cell 111 and the negative electrode of another one battery cell 111.

In some embodiments, the busbar may be an aluminum bar. The aluminum bar has a lower resistance and a lower price, and the aluminum bar has higher material weldability with the positive electrode and the negative electrode. The aluminum bar can reduce contact resistance between the busbar and the battery cell 111.

A total output terminal is provided at each of two ends of the battery cell assembly 11. The total output terminal refers to one electrode of the outermost battery cell 111. An output member is connected to the total output terminal. The output member may be an aluminum bar.

In some embodiments, the output member and a connecting component can be connected by a stud, ultrasonic welding, or hot pressing welding.

The end plate 12 may be a plastic end plate, a metal end plate, or a composite end plate. In this way, the end plate 12 has higher strength to withstand expansion and deformation of the battery cell 111, and to withstand vibration and impact of an energy storage battery pack; and the end plate 12 has a light weight to achieve lightness in terms of weight. The composite end plate refers to an end plate 12 made of metal and plastic. For example, plastic is wrapped around a surface of the metal end plate. The composite end plate has high strength and can also prevent the problem of short circuit between the end plate 12 and the battery cell 111 and the problem of possible corrosion of the end plate 12.

The strip 2 may be made of a material including stainless steel, high-strength steel, or plastic. The strip 2 is generally annular. After the battery cells 111 are stacked and pressed together, the strip 2 is arranged around the end plates 12 to achieve a fixation function. For example, a joint of the metal strip 2 may be implemented by laser welding, metal lock, or the like. A joint of the plastic strip 2 may be implemented by hot-melt connection. In consideration of a dimension requirement, insulation protection, and other issues, the joint is generally arranged at a position of the end plate 12.

In some embodiments, the end plate 12 is a metal end plate, and the strip 2 is made of a conductive material. An insulating plate is provided between the end plate 12 and the battery cell assembly 11, and an insulating plate is provided between the strip 2 and the battery cell 111.

As shown in FIG. 2, in some embodiments, the end plate 12 is provided with at least two engaging structures 13 in a width direction Y of the energy storage module 10, and the at least two engaging structures 13 are arranged at intervals.

For example, in the width direction Y of the energy storage module 10, the end plate 12 may be provided with two, three, or more engaging structures 13. Referring to FIG. 1 together, these engaging structures 13 can be configured to fix a same strip 2. Such a design makes the strip 2 to be limited by the corresponding engaging structure 13 at certain intervals. By increasing the fixing positions of the strip 2, it is conducive to further improving stability of mounting of the strip 2 on the end plate 12 and reducing a possibility of deviation of the strip 2, thereby helping improve stability of connection between the end plate 12 and the battery cell assembly 11.

For example, the end plate 12 may be provided with two engaging structures 13, and in the width direction Y of the energy storage module 10, the two engaging structures 13 are located at two sides of the end plate 12 respectively.

As shown in FIG. 1 and FIG. 2, in some embodiments, the energy storage module 10 includes a plurality of strips 2 arranged in a height direction Z of the energy storage module 10. The end plate 12 is provided with a plurality of engaging structures 13 in the height direction Z of the energy storage module 10. The engaging structure 13 are configured to fit the corresponding strip 2.

The battery cell assembly 11 and the end plate 12 may be fixed by a plurality of strips 2. Two, three, or more strips 2 may be provided. The engaging structure 13 is arranged correspondingly to the strip 2, in such a manner that each strip 2 can be fixed through the corresponding engaging structure 13. For example, two strips 2 are provided, and in the height direction Z of the energy storage module 10, the two strips 2 are arranged around two sides of the body portion 1, respectively. Correspondingly, the end plate 12 is provided with two engaging structures 13 arranged in the height direction Z of the energy storage module 10, and the two engaging structures 13 have a limiting effect on the two corresponding strips 2, respectively. By providing the plurality of strips 2, it is conducive to improving stability and reliability of connection between the battery cell assembly 11 and the end plate 12 and reducing a possibility of detachment of the end plate 12 from the battery cell assembly 11. Moreover, each strip 2 has a corresponding engaging structure 13 to fit therewith, thereby helping improve stability of mounting of each strip 2 and reduce a possibility of deviation of the strip 2.

In the embodiments of the present disclosure, the end plate 12 may alternatively be provided with two, three, or more engaging structures 13 along the width direction Y of the energy storage module 10. That is, each strip 2 can be limited and fixed by at least two engaging structures 13.

As shown in FIG. 1 to FIG. 3, in some embodiments, the engaging structure 13

includes a first engaging member 131 and a second engaging member 133 that protrude towards a direction away from the battery cell assembly 11. The first engaging member 131 and the second engaging member 133 are arranged at intervals in the height direction Z of the energy storage module 10, and the engaging space 132 is located between the first engaging member 131 and the second engaging member 133. In the height direction of the energy storage module 10, an end of the strip 2 abuts against the first engaging member 131, and another end of the strip 2 abuts against the second engaging member 133.

The first engaging member 131 and the second engaging member 133 may be arranged at a surface of the end plate 12 away from the battery cell assembly 11. For example, the first engaging member 131 may be a first limiting block protruding relative to the surface of the end plate 12. The second engaging member 133 may be a second limiting block protruding relative to the surface of the end plate 12. After the strip 2 extends into the engaging space 132, one side of the strip 2 along a Z-axis direction may abut against the first engaging member 131, and the other side of the strip 2 along the Z-axis direction may abut against the second engaging member 133. That is, the strip 2 is clamped between the first engaging member 131 and the second engaging member 133, so as to limit a position of the strip 2 in the height direction Z of the energy storage module 10.

The engaging structure 13 can achieve mutual fitness between the strip 2 and the end plate 12 to prevent the strip 2 from detaching from the end plate 12. The end plate 12 and the strip 2 are engaged to be fixed relative to each other by providing the first engaging member 131 and the second engaging member 133. In this way, in actual use, a probability that the end plate 12 and the strip 2 are detached from each other is reduced, thereby improving reliability between the end plate 12 and the strip 2. Meanwhile, the arrangement of the first engaging member 131 and the second engaging member 133 at the end plate 12 may not have a great impact on the strength and structure of the end plate 12. In this way, on the basis of ensuring mutual fitness between the end plate 12 and the strip 2, the end plate 12 and the strip 2 also have higher strength to withstand expansion and deformation of the battery cell 111.

In some embodiments, the second engaging member 133 has an engaging groove in communication with the engaging space 132, and a partial structure of the strip 2 is located in the engaging groove to limit a position of the strip 2 in the length direction X of the energy storage module 10.

For example, the end plate 12 has a U-shaped groove or a V-shaped groove, and the U-shaped groove or the V-shaped groove constitutes the second engaging member 133. Part of the strip 2 is located in the U-shaped groove or in the V-shaped groove. Structural characteristics of the U-shaped groove or the V-shaped groove make the strip 2 be engaged in the groove, and two opposite sides of the strip 2 abut against an upper top surface and a lower bottom surface of the groove respectively. In this way, the strip 2 can be locked in three directions, thereby providing higher fixity and improving stability and reliability between the strip 2 and the end plate 12. It is to be noted that the U-shaped groove or the V-shaped groove refers to a through groove surrounded by the upper top surface and the lower bottom surface that are opposite to each other in an arrangement direction of the battery cells 111. A specific structure of the U-shaped groove or the V-shaped groove is not limited in the present disclosure.

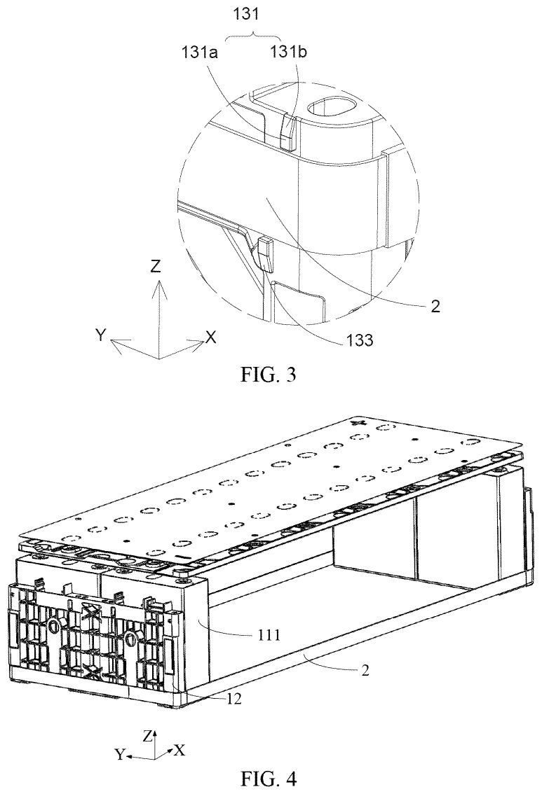

As shown in FIG. 2 and FIG. 3, in some embodiments, the first engaging member 131 and the second engaging member 133 are arranged at intervals in a width direction Y of the energy storage module 10.

In the width direction Y of the energy storage module 10, the first engaging member 131 and the second engaging member 133 are arranged in a staggered manner. That is, there is a certain distance between the first engaging member 131 and the second engaging member 133 in the width direction Y of the energy storage module 10. In this way, the strip 2 can be subjected to forces in two different directions, thereby further helping improve stability and reliability of mounting of the strip 2 on the end plate 12.

As shown in FIG. 2 and FIG. 3, in some embodiments, the first engaging member 131 and/or the second engaging member 133 include/includes an engaging portion 131a and a guiding portion 131b. In the height direction Z of the energy storage module 10, the engaging portion 131a is located at a side of the guiding portion 131b close to the engaging space 132 and is connected to the guiding portion 131b. A cross-sectional area of the guiding portion 131b gradually decreases along a direction away from the engaging portion 131a.

In the height direction Z of the energy storage module 10, the guiding portion 131b has a larger dimension at a side close to the engaging portion 131a and has a smaller dimension at a side away from the engaging portion 131a, so that the guiding portion 131b has an upper surface inclined relative to the engaging portion 131a. Therefore, when mounting the strip 2, the guiding portion 131b can have a guiding effect on the strip 2, so that the strip 2 can enter the engaging space 132 along the upper surface of the guiding portion 131b. This helps realize fitness between the strip 2 and an engaging assembly, facilitates extension of the strip 2 into the engaging space 132, and also helps reduce mounting difficulty of the strip 2, thereby helping improve mounting efficiency of the strip 2.

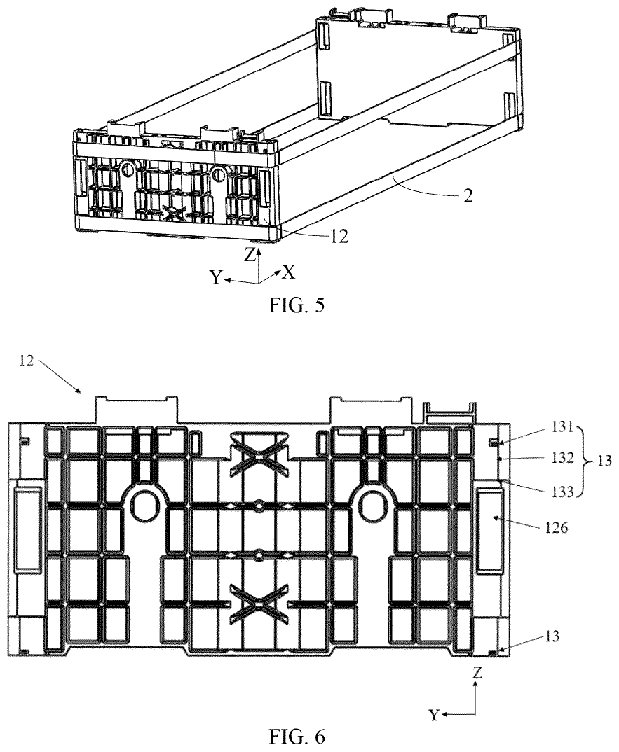

As shown in FIG. 4 and FIG. 5, in some embodiments, the battery cell assembly 11 includes at least one column of battery cells 111 arranged along an X-axis direction. For example, a plurality of columns of battery cells 111 may be arranged along the width direction Y of the energy storage module 10. In the width direction Y of the energy storage module 10, a length of the end plate 12 is greater than or equal to a width of the battery cell assembly 11.

As shown in FIG. 4 and FIG. 5, in some embodiments, the battery cell assembly 11 includes two columns of battery cells 111 arranged along the width direction Y of the energy storage module 10. The end plate 12 has a fixation portion (not shown in the figures). The fixation portion may be located at a side of the engaging structure 13 along a Y-axis direction, and the fixation portion is in contact with the strip 2. In this way, the end plate 12 and the strip 2 can be designed based on different battery cells 111, and this solution has high practicability.

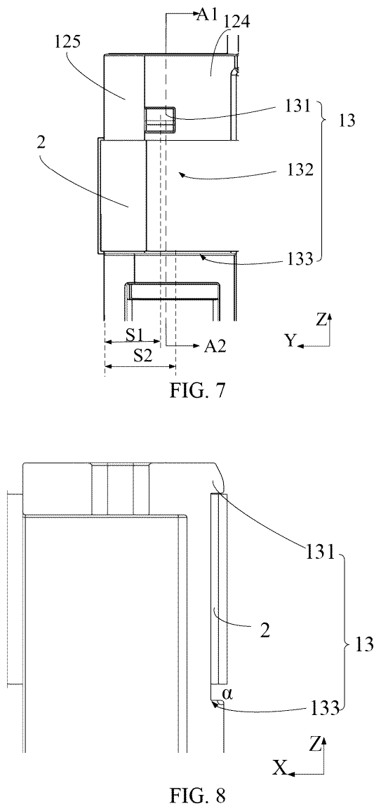

As shown in FIG. 6 and FIG. 7, in some embodiments, in the width direction Y of the energy storage module 10, a dimension of the first engaging member 131 is less than a dimension of the second engaging member 133; and in the height direction Z of the energy storage module 10, a projection of the first engaging member 131 is located within a projection of the second engaging member 133.

A width of the first engaging member 131 in the Y-axis direction is less than a width of the second engaging member 133 in the Y-axis direction. That is, the width of the first engaging member 131 is smaller, and the width of the second engaging member 133 is larger. For the first engaging member 131 having a smaller width, assembling between the end plate 12 and the strip 2 is relatively easy, and there is no need to traverse an obstacle having a larger width, thereby reducing assembling difficulty. When the width of the first engaging member 131 is smaller, the first engaging member 131 may also be smaller accordingly, thereby reducing deformation of the end plate 12 or the strip 2 so that the end plate 12 and the strip 2 have higher strength. For the second engaging member 133 having a larger width, a contact area and an abutment area between the end plate 12 and the strip 2 also increase accordingly. A larger contact area can prevent detachment and deformation between the end plate 12 and the strip 2, thereby improving reliability of the end plate 12 and the strip 2. A projection of the first engaging member 131 being located within a projection of the second engaging member 133 means that the first engaging member 131 and the second engaging member 133 overlap with each other in the Z-axis direction. In this way, the first engaging member 131 and the second engaging member 133 can together apply an opposite force to a component to which a force is applied. The opposite force can provide a higher restricting force, thereby preventing detachment of the end plate 12 from the strip 2.

In some embodiments, the width of the first engaging member 131 is ⅕ to ½ times the width of the second engaging member 133. Two engaging members having different widths are provided, and the two engaging members have respective functions. The first engaging member 131 is configured to ensure more convenient traverse of the strip 2, and the second engaging member 133 is configured to support the strip 2.

As shown in FIG. 6, in some embodiments, the energy storage module 10 includes at least two engaging structures 13 and a reinforcing structure 126. The reinforcing structure 126 is provided at the end plate 12, and may protrude from the surface of the end plate 12. Two ends of the reinforcing structure 126 in the Z-axis direction may respectively serve as the second engaging members 133 of the two engaging structures 13. Firstly, the design of the reinforcing structure 126 can reduce the weight of the end plate 12, thereby reducing the weight of the entire energy storage module 10. Secondly, the design of the reinforcing structure 126 can improve the strength of the end plate 12, so that the end plate 12 can apply a larger force to the battery cell 111, which can prevent an adverse reaction caused by an expansion force of the battery cell 111 during operation. The second engaging member 133 is formed by a side of the reinforcing structure 126. In this way, by use of the existing design of the reinforcing structure 126, it can reduce the related design of the structure of the end plate 12, thereby reducing a manufacturing process.

As shown in FIG. 7, in some embodiments, a distance between a midpoint of the first engaging member 131 and an end portion of the end plate 12 in the width direction Y of the energy storage module 10 is a first distance S1, a distance between a midpoint of the second engaging member 133 and the end portion of the end plate 12 in the width direction Y of the energy storage module 10 is a second distance S2, and the first distance S1 is less than or equal to the second distance S2. This design makes the position of the first engaging member 131 closer to an edge of the end plate 12. In this way, the engaging structure 13 can limit the strip 2 more evenly, shorten a length not abutting against the engaging structure 13, and prevent detachment caused by deformation of the longer strip 2.

As shown in FIG. 7, in some embodiments, the end plate 12 includes a side portion 124 and a corner portion 125 located at each of two sides of the side portion 124, and the engaging structure 13 is arranged on the side portion 124.

The strip 2 may be fitted to the corner portion 125, with a small gap therebetween, which helps improve contact performance between the end plate 12 and the strip 2. The corner portion 125 may be a rounded corner portion, and the strip 2 is fitted to an edge of the end plate 12 in a manner of rounded transition, to prevent loosening of the strip 2. For the strip 2 having high strength, the rounded transition may ensure a larger contact surface between the strip 2 and the end plate 12, and then friction between the strip 2 and the end plate 12 can enhance a fixing force between the strip 2 and the end plate 12.

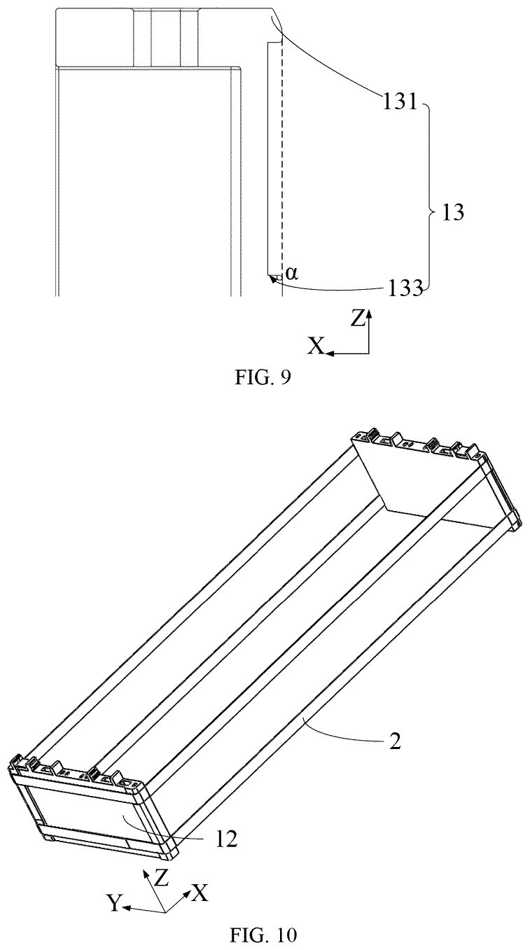

As shown in FIG. 8 and FIG. 9, in some embodiments, a protruding height of the second engaging member 133 is greater than a protruding height of the first engaging member 131.

A surface of the second engaging member 133 is higher than or flush with a surface of the first engaging member 131. In this way, the second engaging member 133 can serve as an abutment surface to bear the gravity of the strip 2, which can prevent slipping and detachment of the strip 2. The lower height of the first engaging member 131 helps reduce difficulty of traversing the strip 2 from the first engaging member 131, thereby improving manufacturing efficiency.

In some embodiments, a protruding height of the first engaging member 131 and/or the second engaging member 133 ranges from 0 mm to 3 mm. The height of at least one of the first engaging member 131 and the second engaging member 133 is within the above-mentioned range, so that a space occupied by the end plate 12 and the strip 2 in the energy storage module 10 is more appropriate, and the entire energy storage module 10 has a high level in terms of integration. Meanwhile, by limiting the protruding height of the first engaging member 131 and/or the second engaging member 133, the end plate 12 has higher strength, thereby helping prolong the service life of the end plate 12.

As shown in FIG. 8 and FIG. 9, in some embodiments, an end of the second engaging member 133 close to the first engaging member 131 has a guiding surface. An angle α between the guiding surface and the end plate 12 ranges from 90° to 150°.

A surface of the second engaging member 133 facing the first engaging member 131 may be an inclined surface. That is, the above-mentioned guiding surface is inclined. The angle α between the inclined surface and the surface of the end plate 12 ranges from 90° to 150°. The inclined surface may be used as a chamfer, which can facilitate positioning of the strip 2 in the engaging groove (not shown in the figures) surrounded by the second engaging member 133. The engaging groove can fix and receive the strip 2, thereby effectively preventing detachment of the strip 2 from the end plate 12.

In some embodiments, the strip 2 includes an engaging protrusion 21. An engaging space 132 is formed between the first engaging member 131 and the second engaging member 133. The engaging protrusion 21 can extend into and engage in the engaging space 132, to limit a relative position between the strip 2 and the end plate 12.

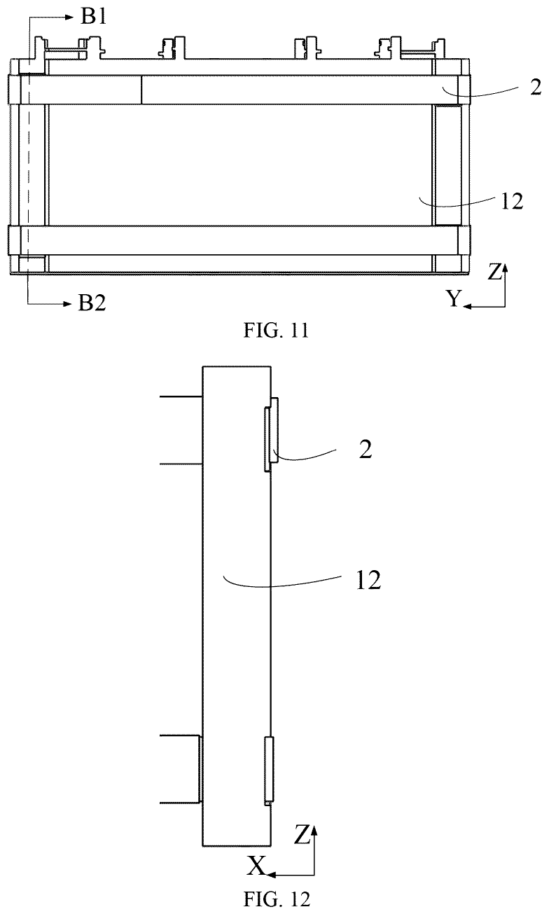

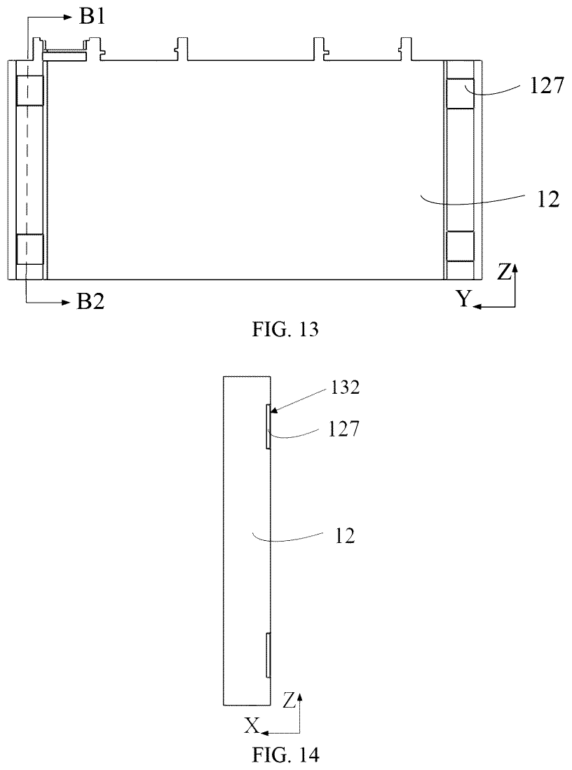

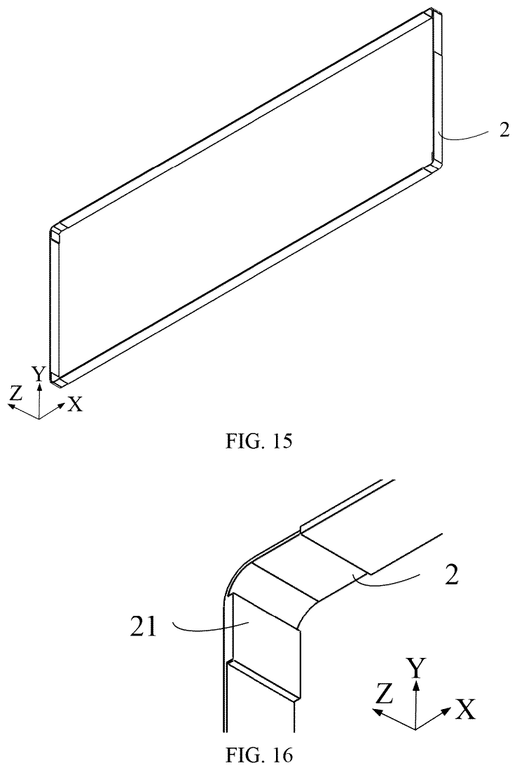

As shown in FIG. 10 to FIG. 16, in some embodiments, the engaging structure 13 includes a recess 127 provided at the end plate 12. The recess 127 is recessed towards the battery cell assembly 11, and the engaging space 132 is located in the recess 127. The strip 2 includes an engaging protrusion 21, and the engaging protrusion 21 is engaged in the engaging space 132.

For example, as shown in FIG. 14, the end plate 12 may include a recess 127 to form the above engaging space 132. The recess 127 is recessed from the surface of the end plate 12 towards the battery cell assembly 11. That is, the recess 127 is recessed towards the interior of the end plate 12. As shown in FIG. 16, the strip 2 includes an engaging protrusion 21, and the engaging protrusion 21 extends into and engages in the engaging space 132 of the end plate 12 to limit a relative position between the strip 2 and the end plate 12. The engaging protrusion 21 fits/matches the recess 127, that is, fits/matches the engaging space 132, so that the engaging space 132 has a limiting effect on the engaging protrusion 21, thereby limiting the overall position of the strip 2. This design helps reduce difficulty of positioning of the strip 2, thereby improving efficiency of assembly of the strip 2 and the end plate 12. In the embodiments, the engaging protrusion 21 may be provided in any direction within a plane of the strip 2, as long as a requirement for fitness between the strip 2 and the engaging space 132 is met, so as to prevent sliding and even detachment of the strip 2.

In some embodiments, the engaging protrusion 21 is provided with a fitting hole, the engaging space 132 is provided with a fitting protrusion, and the fitting protrusion fits/matches the fitting hole.

The fitting hole may be a through hole that runs through the entire strip 2. The through hole may be formed by drilling the strip 2, and the process thereof is relatively simple. Alternatively, the engaging protrusion 21 may be provided with a notch. The notch may be snap-fitted with the fitting protrusion to achieve fixation between the strip 2 and the end plate 12. This design helps further improve stability and reliability of fitness between the engaging protrusion 21 and the engaging space 132, thereby reducing a possibility of falling of the strip 2 off the end plate 12.

In some embodiments, in a width direction of the strip 2, a ratio of a dimension of the engaging protrusion 21 to a dimension of the strip 2 ranges from 1% to 20%.

In the width direction of the strip 2, a ratio of a width of the engaging protrusion 21 to a width of the strip 2 ranges from 1% to 20%. The ratio may be 1%, 6%, 21%, 13%, 16%, or 20%. When the ratio is within the above-mentioned range, the strip 2 has a smaller area for forming through holes and notches and also has a larger area to achieve a fixing effect of the strip 2, and the strip 2 has higher strength and toughness to ensure that the strip 2 ameliorates adverse effects caused by expansion of the battery cell 111.

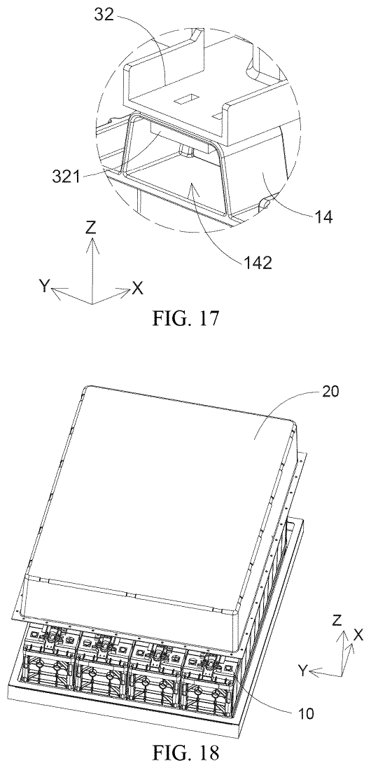

As shown in FIG. 1, FIG. 2, and FIG. 17, in some embodiments, the energy storage module 10 includes a collection assembly 3 located at a side of the body portion 1 along the height direction Z of the energy storage module 10. The collection assembly 3 includes a main body portion 31 extending along the length direction X of the energy storage module 10, and each of two ends of the main body portion 31 is provided with a fitting portion 32 connected to the corresponding end plate 12. A side of the end plate 12 close to the collection assembly 3 is provided with a limiting portion 14. Along the height direction Z of the energy storage module 10, the limiting portion 14 is provided with a limiting groove 141, the fitting portion 32 includes a limiting protrusion 321 extending towards the limiting portion 14, and the limiting protrusion 321 can extend into the limiting groove 141 to limit a position of the main body portion 31.

The collection assembly 3 may collect data such as a temperature and a voltage of the battery cell assembly 11, thereby monitoring a state of the battery cell assembly 11. A main body portion 31 of the collection assembly 3 may be configured to fix cables and other electronic elements in the energy storage module 10. Each of two sides of the main body portion 31 is provided with a fitting portion 32. The fitting portion 32 includes a limiting protrusion 321 extending towards the end plate 12 along the height direction Z of the energy storage module 10, and the end plate 12 is provided with a limiting portion 14 extending towards the main body portion 31 along the height direction Z of the energy storage module 10. The limiting portion 14 is provided with a limiting groove 141, and the limiting protrusion 321 can extend into the limiting groove 141, thereby having a limiting effect on the main body portion 31. For example, the limiting portion 14 has an accommodation cavity 142, the limiting groove 141 is provided at the top of the limiting portion 14, and the limiting groove 141 is in communication with the accommodation cavity 142. The limiting protrusion 321 can extend into the accommodation cavity 142 through the limiting groove 141. For example, the limiting protrusion 321 has a preset dimension along the height direction Z of the energy storage module 10, the dimension may be designed according to an actual use requirement. The accommodation cavity 142 can accommodate part of the limiting protrusion 321 or accommodate all of the limiting protrusion 321. By limiting the dimension of the limiting protrusion 321, it is conducive to improving structural strength of the limiting protrusion 321, thereby helping improve stability of fitness between the limiting protrusion 321 and the limiting groove 141 and helping improve the limiting effect on the main body portion 31.

Through the fitness between the limiting protrusion 321 and the limiting groove 141, it is conducive to limiting a relative position between the main body portion 31 and the end plate 12, thereby reducing deviation of the main body portion 31 relative to the end plate 12 and helping improve stability of mounting of the main body portion 31 and the entire collection assembly in the energy storage module 10, so as to improve operational stability and reliability of the energy storage module 10.

As shown in FIG. 2, in some embodiments, the end plate 12 is further provided with at least one fixation groove 15. The fixation groove 15 is located at one side of the limiting portion 14, and the fixation groove 15extends along the height direction Z of the energy storage module 10. The fixation groove 15 is configured to mount and fix an electronic element (not shown in the figures) in the energy storage module 10.

For example, in the width direction Y of the energy storage module 10, the fixation groove 15 may be arranged at each of two sides of the limiting portion 14. The fixation groove 15 can provide a mounting space for some electronic elements in the energy storage module 10 and can fix these electronic elements. Through the arrangement of the fixation groove 15 at the end plate 12, it is conducive to rational utilization of a space of the end plate 12, thereby helping realize a compact design inside the energy storage module 10. At the same time, the fixation groove 15 can have mounting and fixing effects on some electronic elements, thereby helping improve stability of an internal structure of the energy storage module 10 and facilitating normal and stable operation of the energy storage module 10.

As shown in FIG. 2, in some embodiments, the fixation groove 15 includes a first side wall 151 and a second side wall 152 arranged along the width direction Y of the energy storage module 10. The first side wall 151 and the second side wall 152 are each provided with a protruding portion 153 protruding towards an inner side of the fixation groove 15, and the protruding portion 153 is configured to fit the electronic element.

The first side wall 151 and the second side wall 152 both can extend along the height direction Z of the energy storage module 10, and each are provided with a protruding portion 153. For example, the protruding portion 153 of the first side wall 151 and the protruding portion 153 of the second side wall 152 may be arranged opposite to each other; or according to an actual use requirement, and the protruding portion 153 of the first side wall 151 and the protruding portion 153 of the second side wall 152 may be arranged in a staggered manner along the length direction X of the energy storage module 10. For example, one, two, three, or more protruding portions 153 may be provided at each of the first side wall 151 and the second side wall 152, and the number of the protruding portion(s) 153 provided at the first side wall 151 may be the same as or different from the number of the protruding portion(s) 153 at provided at the second side wall 152. The protruding portion 153 can be engaged with the electronic element so that the fixation groove 15 can mount and fix the electronic element located therein, thereby helping improve stability of the electronic element placed inside the fixation groove 15.

As shown in FIG. 2, in some embodiments, a reinforcing rib 16 is provided at a side of the end plate 12 away from the battery cell assembly 11. The reinforcing rib 16 includes at least a first reinforcing portion 161. The first reinforcing portion 161 is provided with a first lifting hole 161a in the length direction X of the energy storage module 10, and the first lifting hole 161a is configured to fit a lifting arm (not shown) of a crane.

A side of the end plate 12 away from the battery cell assembly 11 is provided with a cavity 121. The cavity 121 extends along the length direction X of the energy storage module 10. The reinforcing rib 16 is arranged in the cavity 121 and extends towards a side away from the battery cell assembly 11 along the length direction X of the energy storage module 10. The reinforcing rib 16 includes a first reinforcing portion 161, a second reinforcing portion 162, a third reinforcing portion 163, and a fourth reinforcing portion 164. The first reinforcing portion 161 is provided with a first lifting hole 161aa. The lifting arm of the crane can fit/match the first lifting hole 161aa to facilitate transfer of the end plate 12 or the entire energy storage module 10. The second reinforcing portion 162 may extend along the height direction Z of the energy storage module 10, the third reinforcing portion 163 may extend along the width direction Y of the energy storage module 10, and the first reinforcing portion 161 may be connected to the second reinforcing portion 162 and the third reinforcing portion 163. Certainly, the first reinforcing portion 161 may alternatively be arranged at another position in the cavity 121. The fourth reinforcing portion 164 may be inclined to the second reinforcing portion 162 and the third reinforcing portion 163 and be connected to the second reinforcing portion 162 and the third reinforcing portion 163.

Through the arrangement of the reinforcing rib 16, it is conducive to improving strength of an overall structure of the end plate 12 and reducing a possibility of deformation of the end plate 12 during processing, mounting, or use, thereby helping improve reliability of the entire energy storage module 10. The first reinforcing portion 161 is provided with the first lifting hole 161aa, which helps realize fitness between the end plate 12 and the lifting arm of the crane, thereby facilitating transportation of the end plate 12 and the entire energy storage module 10.

As shown in FIG. 2, in some embodiments, the end plate 12 is provided with a second lifting hole 17 and a third lifting hole 18 along the length direction X of the energy storage module 10; and in the height direction Z of the energy storage module 10, a dimension of the third lifting hole 18 is less than a dimension of the second lifting hole 17, and both the second lifting hole 17 and the third lifting hole 18 are configured to fit/match the lifting arm of the crane.

In the width direction Y of the energy storage module 10, each of two sides of the cavity 121 is provided with a fitting end 122, and the fitting end 122 protrudes from a bottom wall of the cavity 121. The engaging assembly, the second lifting hole 17, and the third lifting hole 18 may all be arranged at the fitting end 122. In the height direction Z of the energy storage module 10, a dimension of the third lifting hole 18 is less than a dimension of the second lifting hole 17, so that the end plate 12 can be adapted to lifting arms having different dimensions, thereby further facilitating transportation of the end plate 12 and the entire energy storage module 10.

As shown in FIG. 2, the fitting end 122 may be further provided with a mounting hole 123. For example, the mounting hole 123 may run through the fitting end 122 along the height direction Z of the energy storage module 10, and the mounting hole 123 can fixedly fit a fastener such as a screw (not shown), thereby realizing connection and fixation of the energy storage module 10 and a housing 20 of a battery pack.

As shown in FIG. 18, some embodiments of the present disclosure further provide a battery pack, including a housing 20 and at least one energy storage module 10. The housing 20 includes an accommodation space. The energy storage module 10 is located in the accommodation space. The energy storage module 10 may be the energy storage module 10 in any one of the above-described embodiments.

The battery pack is an important element in an energy storage system and is configured to store or output electrical energy. The battery pack includes the housing 20, and the energy storage module 10 is received in the housing 20. One or more energy storage modules 10 may be provided. For example, the energy storage modules 10 may be connected in series or in parallel. Through the arrangement of the above-described energy storage module 10, it is conducive to improving operational stability and reliability of the battery pack. The arrangement of the end plate 12 helps increase a distance between the battery cell assembly 11 and the housing 20 and helps reduce a possibility of creepage of the battery cell assembly 11 towards the housing 20 due to an excessively short distance between the battery cell assembly 11 and the housing 20. Since the energy storage module 10 has the above-mentioned technical effects, the battery pack including the energy storage module 10 described above can also achieve the above-mentioned technical effect, which will not be further described in detail herein.

For example, the above-mentioned battery pack may further include a connector, a battery management system, a heat dissipation system, and an electrical interface.

The energy storage modules 10 are connected in parallel or in series, to increase a voltage, a capacity, or power of the battery system. The battery pack is further responsible for providing other functions and characteristics required by the battery system, such as an electrical interface configured for connection to an external system.

The battery management system is responsible for monitoring and managing charging and discharging processes of battery to ensure safety and stable performance of the battery pack. The battery management system can monitor parameters such as a voltage, a temperature, and a current of the battery cell 111, and perform battery state estimation and balance control to prevent over-charge, over-discharge, over-temperature, and the like, and provide a communication interface for data interaction with the external system.

The above-mentioned housing 20 protects the energy storage module 10 and the battery management system, provides physical support and isolation, and also ensures safety and reliability of the entire battery pack. The housing can provide protection and heat dissipation and protect the battery system from damage from an external environment.

The heat dissipation system is configured to control a battery temperature. Through the heat dissipation system, the energy storage module can be effectively cooled to prevent overheating and maintain the battery within a suitable operating temperature range.

The above description merely illustrates some preferred embodiments of the present disclosure and is not intended to limit the present disclosure. For those skilled in the art, the present disclosure may have various modifications and changes. Any modifications, equivalent replacements, improvements, and the like made within a concept of the present disclosure shall fall within a protection scope of the present disclosure.

What is claimed is:

1. An energy storage module, comprising:
a body portion (1), the body portion (1) comprising a battery cell assembly (11) and end plates (12) arranged at two sides of the battery cell assembly (11) in a length direction of the energy storage module (10); and
at least one strip (2), the strip (2) being arranged around an outer side of the body portion (1) along a circumferential direction of the body portion (1) to fix the battery cell assembly (11) and the end plates (12),
wherein at least one engaging structure (13) is provided at a side of each of the end plates (12) away from the battery cell assembly (11), the engaging structure (13) comprising an engaging space (132), and part of the strip (2) is located in the engaging space (132) to limit a relative position between the end plate (12) and the strip (2).

2. The energy storage module according to claim 1, wherein the engaging structure (13) comprises a first engaging member (131) and a second engaging member (133) that protrude towards a direction away from the battery cell assembly (11);
the first engaging member (131) and the second engaging member (133) are arranged at intervals along a height direction of the energy storage module (10), and the engaging space (132) is located between the first engaging member (131) and the second engaging member (133); and
in the height direction of the energy storage module (10), an end of the strip (2) abuts against the first engaging member (131), and another end of the strip (2) abuts against the second engaging member (133).

3. The energy storage module according to claim 2, wherein the second engaging member (133) comprises an engaging groove in communication with the engaging space (132); and
part of the strip (2) is located in the engaging groove to limit a position of the strip (2) in the length direction of the energy storage module (10).

4. The energy storage module according to claim 2, wherein the first engaging member (131) and the second engaging member (133) are arranged at intervals along a width direction of the energy storage module (10).

5. The energy storage module according to claim 4, wherein at least one of the first engaging member (131) or the second engaging member (133) comprises an engaging portion (131a) and a guiding portion (131b); and
in the height direction of the energy storage module (10), the engaging portion (131a) is located at a side of the guiding portion (131b) close to the engaging space (132) and is connected to the guiding portion (131b); and a cross-sectional area of the guiding portion (131b) decreases along a direction away from the engaging portion (131a).

6. The energy storage module according to claim 2, wherein in a width direction of the energy storage module (10), a dimension of the first engaging member (131) is less than a dimension of the second engaging member (133); and
along the height direction of the energy storage module (10), a projection of the first engaging member (131) is located within a projection of the second engaging member (133).

7. The energy storage module according to claim 6, wherein in the width direction of the energy storage module (10), a distance between a midpoint of the first engaging member (131) and an end portion of the end plate (12) is a first distance S1, and a distance between a midpoint of the second engaging member (133) and the end portion of the end plate (12) is a second distance S2; and wherein the first distance S1 is less than or equal to the second distance S2.

8. The energy storage module according to claim 6, wherein a protruding height of the second engaging member (133) is greater than a protruding height of the first engaging member (131).

9. The energy storage module according to claim 6, wherein a protruding height of the first engaging member (133) and/or the second engaging member (131) ranges from 0 mm to 3 mm.

10. The energy storage module according to claim 6, wherein the second engaging member (133) comprises a guiding surface at an end close to the first engaging member (131); and
an angle α formed between the guiding surface and the end plate (12) ranges from 90° to 150°.

11. The energy storage module according to claim 1, wherein the engaging structure (13) comprises a recess (127) arranged at the end plate (12), the recess (127) is recessed towards the battery cell assembly (11), and the engaging space (132) is located in the recess (127); and
the strip (2) comprises an engaging protrusion (21) engaged in the engaging space (132).

12. The energy storage module according to claim 11, wherein the engaging protrusion (21) is provided with a fitting hole; and
the engaging space (132) is provided with a fitting protrusion that fits the fitting hole.

13. The energy storage module according to claim 12, wherein in a width direction of the strip (2), a ratio of a dimension of the engaging protrusion (21) to a dimension of the strip (2) ranges from 1% to 20%.

14. The energy storage module according to claim 1, wherein the end plate (12) comprises a side portion (124) and corner portions (125) located at two sides of the side portion (124), and the engaging structure (13) is arranged at the side portion (124).

15. The energy storage module according to claim 1, wherein the energy storage module (10) comprises a collection assembly (3) located at a side of the body portion (1) along a height direction of the energy storage module (10); and
the collection assembly (3) comprises a main body portion (31) extending along the length direction of the energy storage module (10), and each of two ends of the main body portion (31) is provided with a fitting portion (32) connected to a corresponding end plate (12) of the end plates (12); and
the end plate (12) is provided with a limiting portion (14) at a side close to the collection assembly (3), the limiting portion (14) is provided with a limiting groove (141) along the height direction of the energy storage module (10), and the fitting portion (32) comprises a limiting protrusion (321) extending towards the limiting portion (14); and the limiting protrusion (321) is capable of extending into the limiting groove (141) to limit a position of the main body portion (31).

16. The energy storage module according to claim 15, wherein the end plate (12) is further provided with at least one fixation groove (15) at a side of the limiting portion (14) and extending along the height direction of the energy storage module (10), and the fixation groove (15) is configured to mount and fix an electronic element in the energy storage module (10).

17. The energy storage module according to claim 16, wherein the fixation groove (15) comprises a first side wall (151) and a second side wall (152) arranged along a width direction of the energy storage module (10), each of the first side wall (151) and the second side wall (152) is provided with a protruding portion (153) protruding towards an inner side of the fixation groove (15), and the protruding portion (153) is configured to fit the electronic element.

18. The energy storage module according to claim 1, wherein the end plate (12) is provided with a reinforcing rib (16) at a side away from the battery cell assembly (11), the reinforcing rib (16) comprises at least a first reinforcing portion (161), the first reinforcing portion (161) is provided with a first lifting hole (161a) along the length direction of the energy storage module (10), and the first lifting hole (161a) is configured to fit a lifting arm of a crane.

19. The energy storage module according to claim 1, wherein the end plate (12) is provided with a second lifting hole (17) and a third lifting hole (18) along the length direction of the energy storage module (10); along a height direction of the energy storage module (10), a dimension of the third lifting hole (18) is less than a dimension of the second lifting hole (17); and each of the second lifting hole (17) and the third lifting hole (18) is configured to fit a lifting arm of a crane.

20. A battery pack, comprising:
a housing (20) comprising an accommodation space; and
at least one energy storage module (10) located in the accommodation space, each of the at least one energy storage module (10) comprises:
a body portion (1), the body portion (1) comprising a battery cell assembly (11) and end plates (12) arranged at two sides of the battery cell assembly (11) in a length direction of the energy storage module (10); and
at least one strip (2), the strip (2) being arranged around an outer side of the body portion (1) along a circumferential direction of the body portion (1) to fix the battery cell assembly (11) and the end plates (12),
wherein at least one engaging structure (13) is provided at a side of each of the end plates (12) away from the battery cell assembly (11), the engaging structure (13) comprising an engaging space (132). and part of the strip (2) is located in the engaging space (132) to limit a relative position between the end plate (12) and the strip (2).
